(19) United States
(12) Patent Application Publication
(10) Pub. No.: US 2014/0094398 A1
(43) Pub. Date: Apr. 3, 2014

(54) STABLE ENZYME STABILIZER PREMIX

(71) Applicant: The Procter & Gamble Company, Cincinnati, OH (US)

(72) Inventors: Serge Omer Alfons Jean THOOFT, Herzele (BE); Jean-Pol BOUTIQUE, Gembloux (BE); Regine LABEQUE, Neder over Heembeek (BE)

(73) Assignee: The Procter & Gamble Company, Cincinnati, OH (US)

(21) Appl. No.: 14/034,712

(22) Filed: Sep. 24, 2013

(30) Foreign Application Priority Data
Oct. 3, 2012 (EP) 12187080.2

(51) Int. Cl. C11D 3/386

(52) U.S. Cl. CPC C11D 3/38663
USPC 510/405; 510/513

(57) ABSTRACT

The need for a highly concentrated enzyme stabilizer premix, which is both physically and chemically stable, is met by dissolving phenyl boronic acid, or a derivative thereof, to form a premix comprising an organic solvent, while limiting the amount of water present.

### FIELD OF THE INVENTION

Enzyme stabilizer premixes, particularly for use in detergent compositions.

### BACKGROUND OF THE INVENTION

Enzymes are often added to detergent compositions, in order to remove recalcitrant fabric stains such as those composed of proteins, fats, and carbohydrates. The enzymes must be stabilized to prevent them degrading in the detergent compositions, or breaking down other ingredients, such as thickeners derived from cellulosic polymers, other carbohydrates, and hydrogenated castor oil. Suitable enzyme stabilizers include phenyl boronic acid, and derivatives of phenyl boronic acid.

Enzyme stabilizers are typically received from the supplier as a solid. However, solids such as powders, are difficult to accurately dose into a composition, and are also challenging to solubilise into liquid compositions. Therefore, it is highly preferred that the enzyme stabilizer is added to a composition as a low viscosity, preferably highly concentrated, stable, liquid premix. Low viscosity liquid premixes can be easily pumped, accurately dosed, and readily mixed into the detergent composition.

The solubility of phenyl boronic acid, and derivatives thereof, in water is highest under highly alkaline conditions. However, in such high pH aqueous premixes, phenyl boronic acid, and derivatives thereof, rapidly undergo oxidative degradation to form free benzene or phenol. Therefore, such aqueous premixes could only be stored at low temperatures, for short times, to limit degradation, or had to be used immediately after making. However, if the temperature is too low, the phenyl boronic acid, or derivative thereof, will precipitate out of the premix composition. Furthermore, there is a risk of such premixes solidifying during making, if sufficient alkali is not added, to bring the premix to the required pH range.

Therefore, a need remains for a liquid premix of phenyl boronic acid, or derivative thereof, which is both physically and chemically stable, across the ambient temperature range.

WO2007/025549 A1 and WO2008/116915 A1 disclose liquid premixes of enzyme stabilizer compositions.

### SUMMARY OF THE INVENTION

The present invention relates to a liquid premix comprising at least 5% by weight of an enzyme stabilizer selected from: phenyl boronic acid, derivatives of phenyl boronic acid, and mixtures thereof, and at least 10% by weight of organic solvent, characterized in that the premix comprises less than 25% by weight of water.

The present invention further relates to processes for making such premixes, and to the use of such premixes to stabilize an enzyme, preferably a proteolytic enzyme, in a detergent composition.

### DETAILED DESCRIPTION OF THE INVENTION

By dissolving the phenyl boronic acid, or a derivative thereof, into a premix in which the amount of water present is limited to less than 25% by weight, the physical and chemical stability of the liquid enzyme stabilizer premix is improved.

The premixes of the present invention can be made and stored at one location, with minimal degradation, before being transported to another manufacturing site for incorporation into a final detergent composition.

Having a low water or non-aqueous premix also makes it possible to form more concentrated liquid detergent compositions, or non-aqueous liquid detergent compositions, since less water is introduced into the detergent composition. Since such premixes are low in water, they are also suitable for dry, powdered detergent compositions, and the like.

Moreover, by adding an organic solvent into the premix, premixes comprising high concentrations of phenyl boronic acid, or a derivative thereof, can be achieved.

As defined herein, “essentially free of” a component means that no amount of that component is deliberately incorporated into the respective premix, or composition. Preferably, “essentially free of” a component means that no amount of that component is present in the respective premix, or composition.

As used herein, “isotropic” means a clear mixture, having no visible haziness and/or dispersed particles, and having a uniform transparent appearance.

As defined herein, “stable” means that no visible phase separation is observed for a premix kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the premix, unless otherwise specified. All average values are calculated “by weight” of the premix, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Enzyme Stabilizer Premix:

The enzyme stabilizer premix comprises an enzyme stabilizer selected from: phenyl boronic acid, derivatives of phenyl boronic acid, and mixtures thereof. The premix further comprises at least 10% by weight of an organic solvent, and less than 25% by weight of water. Preferably, the premix comprises less than 20%, more preferably less than 15%, even more preferably less than 7%, most preferably less than 1% by weight of water. Alternatively, the premix is essentially free of water.

If water is present, the enzyme stabilizer premix preferably has a pH of greater than 7, more preferably greater than 9, most preferably greater than 9.5, since it is believed that the enzyme stabilizer is more soluble at higher pH. If water is present, the premix preferably has a pH of less than 14, more preferably less than 13, even more preferably less than 12, most preferably less than 10.5. It is believed that the chemical stability of the aqueous premixes of the present invention is even further improved at lower pH.

Any suitable alkali agent may be used, though alkali agents selected from the group consisting of: alkali metals, alkanolamines, and mixtures thereof, are preferred. Suitable alkali metals include sodium hydroxide, potassium hydroxide, and mixtures thereof. Suitable alkanolamines include monoethanolamine, triethanolamine, and mixtures thereof. The alkali agent is preferably selected from sodium hydroxide, monoethanolamine, and mixtures thereof. Sodium hydroxide is the most preferred alkali agent.

In order not to affect the appearance of the final composition, into which the premix is to be added, the enzyme stabilizer premix of the present invention is preferably substantially colourless. For a similar reason, the enzyme stabilizer premix of the present invention is preferably substantially isotropic.

Furthermore, for easy mixing into said final composition, the premix viscosity is preferably less than 3000 mPa·s, more preferably less than 1500 mPa·s, most preferably less than 300 mPa·s, measured at 20 s⁻¹ and 25° C. Preferably, the premix does not comprise any proteolytic enzyme. More preferably, the premix does not comprise any enzyme. Such enzymes are ideally added to the final composition, separately from the enzyme stabilizer premix.

### A) Enzyme Stabilizer:

The enzyme stabilizer premix comprises at least 5% by weight of an enzyme stabilizer selected from: phenyl boronic acid, derivatives of phenyl boronic acid, and mixtures thereof. Preferably, the enzyme stabilizer premix comprises at least 15%, more preferably at least 30% by weight of the enzyme stabilizer. Preferably, the enzyme stabilizer premix comprises no greater than 65%, more preferably no greater than 58%, most preferably no greater than 51% by weight of the enzyme stabilizer.

The most preferred enzyme stabilizer is phenyl boronic acid (PBA). However, derivatives of phenyl boronic acid are also suitable for incorporation into the premix compositions of the present invention. In one embodiment, the enzyme stabilizer is a naphthalene boronic acid derivative. In preferred embodiments, the phenyl boronic acid derivative has the following formula:

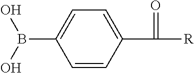

wherein R is selected from the group consisting of hydrogen, hydroxy, C1-C6 alkyl, substituted C1-C6 alkyl, C1-C6 alkenyl and substituted C1-C6 alkenyl. In a more preferred embodiment, R is a C1-C6 alkyl or H. Even more preferably, R is CH₃, CH₃CH₂ or CH₃CH₂CH₂, or H. In another embodiment, the derivative of phenyl boronic acid is 4-formyl-phenyl-boronic acid (4-FPBA).

Other suitable derivatives of boronic acid include: thiophene-2 boronic acid, thiophene-3 boronic acid, (2-Acetamidophenyl)boronic acid, benzofuran-2 boronic acid, naphtalene-1 boronic acid, naphtalene-2 boronic acid, 2-FPBA, 3-FBPA, 4-FPBA, thianthrene-1-boronic acid, 4-dibenzofuran boronic acid, 5-methylthiophene-2 boronic, acid, thionaphthene boronic acid, furan-2 boronic acid, furan-3 boronic acid, 4,4 biphenyl-diboronic acid, 6-Hydroxy-2-naphthaleneboronic acid, 4-(methylthio)phenyl boronic acid, 4-(trimethylsilyl)phenyl boronic acid, 3-bromothiophene boronic acid, 4-methylthiophene boronic acid, 2-naphthyl boronic acid, 5-bromothiophene boronic acid, 5-chlorothiophene boronic acid, dimethylthiophene boronic acid, 2-bromophenyl boronic acid, 3-chlorophenyl boronic acid, 3-methoxy-2-thiophene boronic acid, p-methyl-phenylethyl boronic acid, thianthrene-2-boronic acid, di-benzothiophene boronic acid, 4-carboxyphenyl boronic acid, 9-anthryl boronic acid, 3,5 dichlorophenyl boronic, acid, diphenyl boronic acid anhydride, o-chlorophenyl boronic acid, p-chlorophenyl boronic acid, m-bromophenyl boronic acid, p-bromophenyl boronic acid, p-fluorophenyl boronic acid, p-tolyl boronic acid, o-tolyl boronic acid, octyl boronic acid, 1,3,5 trimethylphenyl boronic acid, 3-chloro-4-fluorophenyl boronic acid, 3-aminophenyl boronic acid, 3,5-bis-(trifluoromethyl) phenyl boronic acid, 2,4 dichlorophenyl boronic acid, 4-methoxyphenyl boronic acid, and mixtures thereof. Further suitable derivatives of boronic acid are described in U.S. Pat. No. 4,963,655, U.S. Pat. No. 5,159,060, WO 95/12655, WO 95/29223, WO 92/19707, WO 94/04653, WO 94/04654, U.S. Pat. No. 5,442,100, U.S. Pat. No. 5,488,157 and U.S. Pat. No. 5,472,628.

### B) Organic Solvent:

The enzyme stabilizer premix comprises at least 10% by weight of an organic solvent. Preferably, the enzyme stabilizer premix comprises from 10% to 95%, more preferably from 17% to 85%, most preferably from 24% to 70% by weight of organic solvent.

When the enzyme stabilizer is substantially free of water, the enzyme stabilizer premix preferably comprises from 35% to 95%, more preferably from 42% to 85%, most preferably from 49 to 70% by weight of the organic solvent. When substantially free of water, the enzyme stabilizer premix preferably comprises water at a level of less than 7%, more preferably less than 1% by weight. Most preferably, the enzyme stabilizer premix is essentially free of water.

When water is present, particularly at a level of greater than 1%, more preferably 7% by weight, the enzyme stabilizer premix preferably comprises from 10% to 35%, more preferably from 15% to 25% by weight of the organic solvent.

The solubility of phenyl boronic acid, and derivatives thereof, has been found to depend on the Hansen Solubility parameter of the organic solvent. The Hansen Solubility Parameter is a three component measuring system that includes a dispersion force component (δ_{d}), a hydrogen bonding component (δₕ), and a polar component (δₚ). The Hansen Solubility Parameter “δ” is derived from the fact that the total cohesive energy, which is the energy required to break all the cohesive bonds, is the combination of the dispersion forces (d), the molecular dipole forces (p), and the hydrogen bonding forces (h), according to the following equation:

δ²=δ_{d}²+δₚ²+δₕ². (1)

Dispersion forces are weak attractive forces between non-polar molecules. The magnitude of these forces depends on the polarizability of the molecule. The dispersion force component, δ_{d}, typically increases with increasing size of the molecule, all other properties being roughly equal. The polar component “δₚ” increases with increasing polarity of the molecule. The hydrogen bonding component “δₕ” is related to the energy of interaction between molecules, arising from hydrogen bonds between hydrogen atoms and electronegative atoms of the adjacent molecule.

Hansen Solubility Parameters at 25° C. can be calculated using ChemSW's Molecular Modelling Pro v.6.1.9 software package which uses an unpublished proprietary algorithm that is based on values published in the Handbook of Solubility Parameters and Other Parameters by Allan F. M. Barton (CRC Press, 1983). All values of the Hansen Solubility Parameter reported herein are in units of MPa^{0.5} (square root of megaPascals). Hansen originally determined the solubility parameter of solvents for polymer solutions. While the Hansen Solubility Parameter calculation has been applied successfully to a wide range of applications such as the solubility of biological materials, characterization of pigments, fillers and fibres, etc., it has not heretofore been adapted to the solubility of phenyl boronic acid, and derivatives thereof.

For improved solubility of the enzyme stabilizer, it is preferable that the dispersion component of the Hansen Solubility Parameter, δ_{d}, of the organic solvent is from 15.5 to 17 MPa^{0.5}. For the same reason, the polar component (δp) of the organic solvent is preferably from 4 to 22 MPa^{0.5}, more preferably from 8 to 21 MPa^{0.5}, most preferably from 12 to 18 MPa^{0.5}. For the same reason, the hydrogen bonding component (δh) of the organic solvent is preferably from 8 to 32 MPa^{0.5}, more preferably from 11 to 27 MPa^{0.5}, even more preferably from 14 to 23 MPa^{0.5}, most preferably from 17 to 22 MPa^{0.5}.

Suitable organic solvents for use in the enzyme stabilizer premixes of the present invention can be selected from the group consisting of: propanediol, diethyleneglycol, dipropyleneglycol, butanol, ethanol, glycerol, butoxyethanol and dimethylsulfoxide, and mixtures thereof. More preferably, the organic solvent can be selected from the group consisting of: diethyleneglycol, dipropyleneglycol, butanol, ethanol, butoxyethanol and dimethylsulfoxide, and mixtures thereof. Most preferably, the organic solvent can be selected from the group consisting of: diethyleneglycol, dipropyleneglycol, and mixtures thereof.

### Detergent Compositions:

The enzyme stabilizer premixes of the present invention can be used to stabilize an enzyme, preferably a proteolytic enzyme such as protease, in a liquid detergent composition, or a solid detergent composition such as a granular or tablet detergent composition. The enzyme stabilizer premixes of the present invention are particularly suited for concentrated liquid detergent compositions, and for non-aqueous liquid detergent compositions.

The enzyme stabilizer premix can be added to a detergent composition by any suitable process. A suitable process for making a liquid detergent composition comprising an enzyme, includes the steps of: providing an enzyme stabilizer premix according to the present invention; and combining the premix with a liquid detergent feed, said liquid detergent feed comprising a surfactant; wherein either the liquid detergent feed comprises the enzyme, or the enzyme is added after the liquid detergent feed and enzyme stabilizer are combined. The enzyme is preferably a proteolytic enzyme. The enzyme can also be part of an enzyme system which comprises multiple enzymes.

Liquid detergent compositions, as described herein, include but are not limited to consumer products such as: shampoos; products for treating fabrics, hard surfaces and any other surfaces in the area of fabric and home care, including: dishwashing, laundry cleaning, laundry and rinse additives, hard surface cleaning including floor and toilet bowl cleaners. A particularly preferred embodiment of the invention is a “liquid laundry detergent composition”. As used herein, “liquid laundry detergent composition” refers to any laundry treatment composition comprising a liquid capable of wetting and cleaning fabric e.g., clothing, in a domestic washing machine. The liquid detergent composition preferably has a neat pH of from 6 to 10.5, measured at 25° C. Liquid detergent compositions can flow at 25° C., and include compositions that have an almost water like viscosity, but also include “gel” compositions that flow slowly and hold their shape for several seconds or minutes.

The liquid detergent compositions of the present invention may comprise from 1% to 70%, preferably from 5% to 60%, more preferably from 10% to 50%, most preferably from 15% to 45% by weight of a surfactant selected from the group consisting of: anionic, nonionic surfactants and mixtures thereof. The preferred weight ratio of anionic to nonionic surfactant is from 100:0 (i.e. no nonionic surfactant) to 5:95, more preferably from 99:1 to 1:4, most preferably from 5:1 to 1.5:1.

The liquid detergent compositions of the present invention preferably comprise from 1 to 50%, more preferably from 5 to 40%, most preferably from 10 to 30% by weight of one or more anionic surfactants. Preferred anionic surfactant are selected from the group consisting of: C11-C18 alkyl benzene sulphonates, C10-C20 branched-chain and random alkyl sulphates, C10-C18 alkyl ethoxy sulphates, mid-chain branched alkyl sulphates, mid-chain branched alkyl alkoxy sulphates, C10-C18 alkyl alkoxy carboxylates comprising 1-5 ethoxy units, modified alkylbenzene sulphonate, C12-C20 methyl ester sulphonate, C10-C18 alpha-olefin sulphonate, C6-C20 sulphosuccinates, and mixtures thereof. However, by nature, every anionic surfactant known in the art of detergent compositions may be used, such as those disclosed in “Surfactant Science Series”, Vol. 7, edited by W. M. Linfield, Marcel Dekker. The liquid detergent compositions preferably comprise at least one sulphonic acid surfactant, such as a linear alkyl benzene sulphonic acid, or the water-soluble salt form of the acid.

The liquid detergent compositions of the present invention preferably comprise up to 30%, more preferably from 1 to 15%, most preferably from 2 to 10% by weight of one or more nonionic surfactants. Suitable nonionic surfactants include, but are not limited to C12-C18 alkyl ethoxylates (“AE”) including the so-called narrow peaked alkyl ethoxylates, C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic®—BASF Corp.), as well as semi polar nonionics (e.g., amine oxides and phosphine oxides). An extensive disclosure of suitable nonionic surfactants can be found in U.S. Pat. No. 3,929,678.

The liquid detergent composition may be dilute or concentrated liquids. Preferably, the liquid detergent composition comprises from 1% to 95% by weight of water and/or non-aminofunctional organic solvent. For concentrated liquid detergent compositions, the composition preferably comprises from 15% to 70%, more preferably from 20% to 50%, most preferably from 25% to 45% by weight of water and/or non-aminofunctional organic solvent. Alternatively, the liquid detergent composition may be almost entirely non-aqueous, and comprise a non-aminofunctional organic solvent. Such liquid detergent compositions may contain very little water. Such non-aqueous liquid detergent compositions preferably comprise less than 15%, more preferably less than 10%, even more preferably less than 7% by weight of water. Most preferably, non-aqueous liquid compositions comprise no intentionally added water, beyond that added as part of another ingredient.

As used herein, “non-aminofunctional organic solvent” refers to any organic solvent, of use in the liquid detergent composition, which contains no amino functional groups. Preferred non-aminofunctional organic solvents are liquid at ambient temperature and pressure (i.e. 21° C. and 1 atmosphere), and comprise carbon, hydrogen and oxygen. More preferred non-aminofunctional organic solvents include monohydric alcohols, dihydric alcohols, polyhydric alcohols, glycerol, glycols, polyalkylene glycols such as polyethylene glycol, and mixtures thereof. Highly preferred are mixtures of solvents, especially mixtures of two or more of the following: lower aliphatic alcohols such as ethanol, propanol, butanol, isopropanol; diols such as 1,2-propanediol or 1,3-propanediol; and glycerol.

The liquid detergent compositions of the present invention may comprise from 0.0001% to 8% by weight of a detersive enzyme which typically provide cleaning performance and/or fabric care benefits. Suitable enzymes can be selected from the group consisting of: lipase, protease, amylase, cellulase, pectate lyase, xyloglucanase, and mixtures thereof. A preferred enzyme combination comprises lipase, protease, cellulase, amylase, and mixtures thereof. The liquid detergent composition preferably comprises a proteolytic enzyme, such as protease. Detersive enzymes are described in greater detail in U.S. Pat. No. 6,579,839.

The liquid detergent composition may also include conventional detergent ingredients selected from the group consisting of: additional surfactants such as amphoteric, zwitterionic, cationic surfactant, and mixtures thereof; further enzyme stabilizers; amphiphilic alkoxylated grease cleaning polymers; clay soil cleaning polymers; soil release polymers; soil suspending polymers; bleaching systems; optical brighteners; hueing dyes; particulate material; perfume and other odour control agents, including perfume delivery systems; hydrotropes; suds suppressors; fabric care benefit agents; pH adjusting agents; dye transfer inhibiting agents; preservatives; non-fabric substantive dyes; and mixtures thereof.

Since the premixes of the present invention have low water content, they are particularly suitable for non-aqueous liquid detergent compositions that are to be enclosed within a water soluble pouch material, to form a unit dose article.

Suitable water soluble pouch materials include polymers, copolymers or derivatives thereof. Preferred polymers, copolymers or derivatives thereof are selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

### Process for Making the Enzyme Stabilizer Premix:

Any suitable means can be used for making the enzyme stabilizer premix of the present invention.

A preferred process for making the enzyme stabilizer premix comprises the steps of: providing a solubilising composition comprising an organic solvent; adding an enzyme stabilizer selected from the group consisting of: phenyl boronic acid, derivatives of phenyl boronic acid, and mixtures thereof, to the solubilising composition comprising the organic solvent; and mixing to fully dissolve the enzyme stabilizer.

The solubilising composition can comprise further ingredients. Alternatively, the solubilising composition can consist only of organic solvent. The solubilising composition can comprise one or several organic solvents.

In the most preferred embodiment the enzyme stabilizer premix is essentially free of water. In other embodiments, the enzyme stabilizer premix comprises less than 25%, preferably less than 20%, more preferably less than 15% by weight of water. If the solubilising composition further comprises water, the process may further comprise a step of adding an alkali agent, such that the final pH of the enzyme stabilizer premix is from 7 to 14, preferably from 9 to 12, more preferably from 9.5 to 10.5. In such embodiments, the step of adding an alkali agent is preferably performed before adding the enzyme stabilizer.

The alkali agent and phenyl boronic acid, or derivative thereof, may alternatively be added incrementally to the mixture of organic solvent and water, in small amounts. In such processes, the pH is adjusted by the incremental addition of the alkali agent, as required, in order to prevent the phenyl boronic acid or derivative thereof from caking or forming a solid mass during making. Any suitable increment can be used.

The enzyme stabilizer is typically added as a powder. Agitation can be used to prevent the enzyme stabilizer from caking or solidifying during making of the premix.

The enzyme stabilizer premixes can be prepared at any suitable temperature, such as from 10 to 50, preferably from 15 to 40, most preferably from 20 to 35° C.

### Methods:

### A) pH Measurement:

The pH is measured on the neat composition, at 25° C., using a Santarius PT-10P pH meter with gel-filled probe (such as the Toledo probe, part number 52 000 100), calibrated according to the instructions manual.

### B) Turbidity (NTU):

The turbidity (measured in NTU: Nephelometric Turbidity Units) is measured using a Hach 2100P turbidity meter calibrated according to the procedure provided by the manufacture. The sample vials are filled with 15 ml of representative sample and capped and cleaned according to the operating instructions. If necessary, the samples are degassed to remove any bubbles either by applying a vacuum or using an ultrasonic bath (see operating manual for procedure). The turbidity is measured using the automatic range selection.

### C) Rheology:

An AR-G2 rheometer from TA Instruments is used for rheological measurements, with a 40 mm standard steel parallel plate, 300 μm gap. All measurements, unless otherwise stated, are conducted according to the instruction manual, at steady state shear rate, at 25° C.

### Examples

The following enzyme stabilizer premixes were made by first mixing together the organic solvents and water, if present. For the premixes which comprise water, the alkali agent (50 wt % sodium hydroxide or monoethanolamine in water) was then added. Finally, the phenyl boronic acid, or derivative thereof was added as a powder, under stifling. Agitation was continued until all the enzyme stabilizer had dissolved. All of the samples were prepared at room temperature (21° C.), without heating or cooling.

Samples of Examples 1 and 2 were placed into 25 ml vials for stability testing. One set of vials was kept for 8 weeks at 4° C., another set was kept at 20° C., and the final set was kept at 35° C.

After the 8 weeks, the presence of free benzene and phenol in the samples were measured using headspace solid-phase microextraction (HS-SPME) and detection by gas chromatography/mass spectrometry (GC/MS), via standard addition calibration. 0.2 g of each sample was diluted into 2 ml of 1,2-propanadiol, and headspace levels of Benzene and Phenol were detected using 75 micron Carboxen/Polydimethylsiloxane SPME fibre. Quantification was carried out by spiking known amounts of benzene or phenol into a sample, in increasing amounts, to generate suitable calibration curves.

| | | Ex 2 | | | | |
|---|---|---|---|---|---|---|
| | Ex 1 | comparative | Ex 3 | Ex 4 | Ex 5 | Ex 6 |
| | Wt % | Wt % | Wt % | Wt % | Wt % | Wt % |
| Diethylene glycol | 70 | — | — | 17.36 | — | — |
| 1,2-Propanediol | — | 27.49 | — | — | 17.43 | 16.54 |
| Dipropylene glycol | — | — | 30.62 | — | — | — |
| Water | — | 37.34 | 10.15 | 17.36 | 24.94 | 16.54 |
| Sodium hydroxide | — | 5.90 | 4.63 | — | 7.52 | — |
| Monoethanolamine | — | — | — | 15.27 | — | 17.30 |
| Phenyl boronic acid | 30 | 29.27 | 54.60 | 50.01 | 50.11 | 49.62 |
| Final pH | — | 9.85 | 7.99 | 9.53 | 10.03 | 9.47 |
| Viscosity cps (at 25° C.) | Not meas. | Not meas. | Not meas. | 2570 | 238 | 2664 |
| Stability: ppm phenol in sol | | | | | | |
| After 8 weeks at 4° C. | 68.4 | 1182.9 | | | | |
| After 8 weeks at 20° C. | 229.7 | 2562.3 | | | | |
| After 8 weeks at 35° C. | 403.0 | 2604.6 | | | | |
| Stability: ppm benzene in sol | | | | | | |
| After 8 weeks at 4° C. | 72.7 | 40639.3 | | | | |
| After 8 weeks at 20° C. | 128.8 | 46915.4 | | | | |
| After 8 weeks at 35° C. | 403.1 | 60255.3 | | | | |

| | Ex 7 | Ex 8 |
|---|---|---|
| | Wt % | Wt % |
| Diethylene glycol | 84.62 | |
| Dipropylene glycol | | 38.79 |
| Water | | 17.37 |
| Sodium hydroxide | | 4.45 |
| 4-formyl-phenyl-boronic acid | 15.38 | 39.39 |
| Final pH | — | 10.14 |
| Viscosity cps (at 25° C.) | 59 | Not meas. |

As can be seen from the stability data, the level of free phenol and benzene, after 8 weeks of storage at temperatures of from 4° C. to 35° C., was substantially less for the enzyme stabilizer premix of the present invention of Example 1, than for comparative Example 2. This is indicative of the much lower rate of decomposition of the phenyl boronic acid in the premix of the present invention.

The premixes of examples 1, and 3 to 8, can be used in any suitable enzyme containing detergent composition. An example of a liquid laundry detergent composition, where such premixes can be incorporated into, is shown below:

| | Wt % |
|---|---|
| Alkylbenzene sulfonate: monoethanolamine neutralised | 21.0 |
| C₁₄₋₁₅ alkyl 8-ethoxylate | 18.0 |
| C₁₂₋₁₈ Fatty acid | 15.0 |
| ²Protease (Purafect Prime ®, 40.6 mg active/g) | 1.5 |
| ³Mannanase (Mannaway ®, 11 mg active/g) | 0.1 |
| ³Xyloglucanase (Whitezyme ®, 20 mg active/g) | 0.2 |
| ³Amylase (Natalase ®, 29.26 mg active/g) | 5.9 |
| A compound having the following general structure: | 2.0 |
| bis((C₂H₅O)(C₂H₄O)n)(CH₃)—N⁺—CₓH₂ₓ—N⁺—(CH₃)— | |
| bis((C₂H₅O)(C₂H₄O)n), wherein n = from 20 to 30, and x = | |
| from 3 to 8, or sulphated or sulphonated variants thereof | |
| Ethoxylated Polyethylenimine¹ | 0.8 |
| Hydroxyethane diphosphonate (HEDP) | 0.8 |
| Fluorescent Brightener⁴ | 0.2 |
| Solvents (1,2 propanediol, ethanol), stabilizers | 15.0 |
| Hydrogenated castor oil derivative structurant | 0.1 |
| Perfume | 1.6 |
| Sodium hydroxide | To pH 8.2 |
| Water** and minors (antifoam, aesthetics) | To 100% |

¹Polyethyleneimine (MW = 600) with 20 ethoxylate groups per —NH.
²Purafect Prime ® is a product of Genencor International, Palo Alto, California, USA
³Natalase ®, Mannaway ® and Whitezyme ® are all products of Novozymes, Bagsvaerd, Denmark.
⁴Fluorescent Brightener can be anyone of Tinopal ® AMS-GX, Tinopal ® CBS-X or Tinopal ® TAS-X B36, or mixtures thereof, all supplied by Ciba Specialty Chemicals, Basel, Switzerland

The enzyme stabilizer premix can be added to the above liquid laundry detergent compositions, in any suitable amount. For instance, the enzyme stabilizer premix is added such that the level of the phenyl boronic acid, or derivative thereof, is 0.02 wt % of the final composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid premix comprising:
at least about 5% by weight of an enzyme stabilizer selected from: phenyl boronic acid, derivatives of phenyl boronic acid, and mixtures thereof;
and at least 10% by weight of organic solvent;
wherein the premix comprises less than about 25% by weight of water.

2. The premix according to claim 1, wherein the premix comprises at least about 15% and no greater than about 65% by weight of the enzyme stabilizer.

3. The premix according to claim 2, wherein the premix comprises at least about 30% and no greater than about 51% by weight of the enzyme stabilizer.

4. The premix according to claim 1, wherein the premix comprises less than about 20% by weight of water.

5. The premix according to claim 4, wherein the premix comprises less than about 15% by weight of water.

6. The premix according to claim 5, wherein the premix comprises less than about 1% by weight of water.

7. The premix according to claim 1, wherein the premix comprises from about 10% to about 95% by weight of organic solvent.

8. The premix according to claim 7, wherein the premix comprises from about 24% to about 70% by weight of organic solvent.

9. The premix according to claim 7, wherein the organic solvent has Hansen Solubility parameters of:
(a) delta polarity (δₚ) of from about 4 to about 22 MPa^{0.5}, and
(b) delta H-bonding (δₕ) of from about 8 to about 32 MPa^{0.5}.

10. The premix according to claim 9, wherein the organic solvent has Hansen Solubility parameters of:
(a) delta polarity (δₚ) of from about 8 to about 21 MPa^{0.5}, and
(b) delta H-bonding (δₕ) of from about 11 to about 27 MPa^{0.5}.

11. The premix according to claim 10, wherein the organic solvent has Hansen Solubility parameters of:
(a) delta polarity (δₚ) of from about 12 to about 18 MPa^{0.5}, and
(b) delta H-bonding (δₕ) of from about 14 to about 23.

12. The premix according to claim 1, wherein the organic solvent is selected from: propanediol, diethyleneglycol, dipropyleneglycol, butanol, ethanol, glycerol, butoxyethanol, dimethylsulfoxide, and mixtures thereof.

13. The premix according to claim 1, wherein the premix does not comprise any enzyme.

14. The premix according to claim 1, wherein the premix is colourless and isotropic.

15. The premix according to claim 1, wherein the premix has a viscosity of less than about 3000 mPa·s at 20 s⁻¹ and 25° C.

16. A process for making an enzyme stabilizer premix according to claim 1, comprising the steps of:
(a) providing a solubilising composition comprising an organic solvent;
(b) adding an enzyme stabilizer selected from the group consisting of phenyl boronic acid, derivatives of phenyl boronic acid, and mixtures thereof, to the solubilising composition comprising the organic solvent; and
(c) mixing to dissolve the enzyme stabilizer.

17. A process according to claim 16, wherein the solubilising composition further comprises water, and wherein the process further comprises the step of adding an alkali agent, such that the final pH of the enzyme stabilizer premix is from about 7 to about 14.

18. A process according to claim 17, wherein the step of adding an alkali agent is performed before adding the enzyme stabilizer.

19. A process for making a liquid detergent composition comprising an enzyme, comprising the steps of:
(a) providing an enzyme stabilizer premix according to claim 1; and
(b) combining the premix with a liquid detergent feed, said liquid detergent feed comprising a surfactant;
wherein either the liquid detergent feed comprises the enzyme, or the enzyme is added after the liquid detergent feed and enzyme stabilizer are combined.

20. The use of a premix according to claim 1, for stabilizing an enzyme in a liquid detergent composition.
